(19) United States
(12) Patent Application Publication
(10) Pub. No.: US 2018/0069580 A1
(43) Pub. Date: Mar. 8, 2018

(54) CELL BRACELET/NECKLACE

(71) Applicant: Shirley Harris-Johnson, Jersey City, NJ (US)

(72) Inventor: Shirley Harris-Johnson, Jersey City, NJ (US)

(21) Appl. No.: 15/700,061

(22) Filed: Sep. 8, 2017

Related U.S. Application Data
(60) Provisional application No. 62/384,941, filed on Sep. 8, 2016.

(51) Int. Cl. H04B 1/3827; H04B 1/3888

(52) U.S. Cl. CPC H04B 1/385; H04B 2001/3861; H04B 1/3888

(57) ABSTRACT

This invention relates to a cellular phone accessory for carrying a cellular phone securely and conveniently. A ring and swivel attachment is attached in a groove along the perimeter of the phone case. The movement of the ring and swivel attachment is constrained in the groove. The ring and swivel attachment can swivel 360 degree around the mobile device along the groove. Further, the ring and swivel attachment is flexible to be adjusted in size and can move or bend forward or backward. A necklace is attached to the phone case via another ring attachment. The size (diameter or perimeter) of the necklace is adjustable by an engagement. The engagement includes a hole with thread and another hole with or without thread such that overlapping portions of the necklace can be changed to change the size of the necklace as the thread is rotated clockwise or anticlockwise.

This application claims priority to a Provisional Patent Application No. 62/384,941 filed on Sep. 8, 2016, which is incorporated herein in its entirety by reference.

### FIELD

The present disclosure is directed to a mobile phone carrying apparatus. More particularly, the disclosure is directed to an apparatus for carrying the mobile phone effortlessly on one of the user's body part.

### BACKGROUND OF THE INVENTION

A cellular telephone is a familiar personal communications accessory which is widely used. Early models were bulky, being carried in motor vehicles or in back packs. Further developed models were stored in the pocket or were clipped onto the belt when not in use. They were, therefore, prone to falling, breaking, or simply being forgotten. A further drawback is related to the time loss created by taking such cellular telephones out of a garment pocket, or belt holder, adjusting the phone's orientation to actuate an answer mode, by opening the mouth piece, or pressing a call receive button, and bringing the unit to the side of the face for use.

Cellular phones (hereinafter called “phones”) are portable and conveniently fit in to bags and pockets of clothing. Users often do not have a single designated place to store their phone when not in use. This frequently causes phone users to scurry around looking for their phone when it rings. Occasionally, this results in the caller terminating the call before the user has answered it.

In order to minimize this problem, users often have a carrier pouch for the phone which is attached to a belt and from which the phone must be retrieved for use. Alternatively, a hands free device comprising a separate earpiece and microphone may be used in which case the cellular phone may be held in a pocket or suspended from a belt. Users of such arrangements are usually unable to see the phone's screen without dislodging or removing the phone from its storage position.

Combination watch and phones, commonly known as cell phones, are carried by men, women and even teenagers, or young adults, and, less frequently, by children, wherever they may travel. These cell phones are small enough to be carried in a pocket or a handbag. Such personal cell phones have also been provided with custom-fitted protective carrying cases in which the phone instrument may be inserted and secured. Many presently available cell phone carrying cases are also furnished with a clip for attaching the carrying case to either the edge of a purse or to the user's waist belt.

Cell phones, are often placed in a shirt or blouse pocket, and should the person bend over, such as when using certain toilet facilities, as the person bends over, the cell phone will frequently fall out onto the floor surrounding the toilet, or worse yet, directly into the water in the toilet bowl. This can also happen when the person bends over a stream, creek, river, seashore, or lake when in a wooded area, a wilderness, or forested area. Once the watch phone falls into the water, it is rapidly lost to view, and even if retrievable, it quickly becomes inoperative, and, in most cases, the cell phone cannot be restored again to operability.

When a cell phone is carried in a pocket or purse or mounted on the user's belt or backpack, the person using the phone must first retrieve the cell phone from its concealed position in a pocket, or purse, or from a carrying case on the user's belt. Once the cell phone is retrieved, it is no longer protected, as it is held in the person's hand. Then, the person must typically actuate selected key switches on the cell phone by the other (free) hand for dialing the phone. The dialed numbers typically are then displayed on a display monitor built into the cell phone. Once this is accomplished, the person must raise the cell phone to one of the person's ears, being held there in that hand for as long as the person using the cell phone is listening and speaking into the cell phone. Following the completion of the call, the cell phone is typically returned to a purse, a pocket in one of the user's garments, such as pants, shirt, or blouse, or to a belt-mounted carrying case. However, in these above-described cell phone handling operations, before being safely returned to the carrying case, the purse or the pocket, these cell phones frequently become misplaced or otherwise separate from their user-owners. In short, cell phones are oftentimes misplaced and lost.

For Example, U.S. Pat App. 20050277452 discloses a personal mobile phone carrying case that includes a wrist band and a transparent retainer attached to the wrist band, so as to allow the mobile phone to be kept in the retainer and the wrist band to be secured to a person's arm. The transparency of the retainer enables a user to use the phone's keypad while the phone is inside the retainer.

Another prior art U.S. Pat. No. 8,714,422 discloses a system to carry the mobile device on wrist brace, the system includes a case to enclose the mobile device; a case tether coupled to the case, a wristband tether coupled to a wrist brace, a finger ring to loop around a finger and a case lock to secure the case in a closed position.

### (F) SUMMARY OF THE INVENTION

In view of the foregoing, one inventive aspect of the various disclosed embodiments is to provide a device for carrying the mobile phone.

The mobile accessory includes a case for enclosing a mobile device, at least one band attachment with snaps attached to the case through at least one swivel attachment. The snaps in the band helps to adjust circumference of the band to fit into one of the body parts, like, hand, wrist, fingers, neck, etc. To facilitate the mobile device into the case, a flip is provided which can be secured to a snap provided onto the mobile case to lock the mobile device into the mobile case. This flip can be on one of the sides of the case, preferably on top or on left or right side of the mobile case.

The band can be provided at the back of the case to be worn on the hand or at top of the case to be worn on to the neck.

In one embodiment, two bands are provided at back of the case, so that one can be worn around wrist and another can be worn around fingers to provide a better grip and holding to the mobile accessory. Both the bands can be connected through a single strip, or strips extending from each of the bands can be connected to same swivel attachment, to further improve the grip over the case.

The band attachment with snaps can be pulled through and closed by a velcro for adjusting the length of the band.

The swivel at the back of the case through which one of the bands are connected, can be moved left or right using a guided horizontal trajectory, or up or down using a vertical guided trajectory.

In one embodiment, on back of the case, a ring passes through the swivel, and through the ring a strap passes, wherein two bands, upper band and lower band are attached to at a distance. The distance between the bands can be adjusted by adjusting length of the strap to be locked into one of the snaps through a locking mechanism provided at the end of the strap which passes through the ring.

In an embodiment, one or more bands include a guide portion and a lock configured to adjust and lock the circumference to a desired length.

In another embodiment, one or more bands include a groove portion wherein a part of band slides through the groove portion to allow fast retraction and extension of the band to adjust the circumferential length.

In an example embodiment, a mobile device accessory comprises: a case for enclosing the mobile device; an adjustable necklace having a first engagement configured to attach to end portions of the necklace together so that an overlap of the end portions of the necklace can be increased or decreased to change the size of the necklace; and a first ring attachment configured to attach the necklace to the case.

In a further embodiment, the first engagement is an oval shaped elastic engagement.

In a further embodiment, the first engagement is a clip or snap engagement.

In a further embodiment, the first engagement includes a first hole to receive a first end portion of the necklace and a rotatable pipe including threads in the inner side to receive a second end portion of the necklace such that when the rotatable pipe is rotated the overlap portions of the necklace changes to change the size or diameter of the necklace.

In another example embodiment, an accessory for carrying a mobile device comprises: a case for the mobile device; at least one swivel attachment; and a groove formed on a perimeter and back of the case, the groove being configured to receive and retain the swivel attachment, and allow movement of the swivel attachment along the groove.

In another example embodiment, an accessory for carrying a mobile device comprises: a case for the mobile device; at least one swivel attachment; a first groove formed at a back of the case, the first groove being configured to receive and retain the first end of the swivel attachment, and allow movement of the swivel attachment along the first groove; a first band attachment with the snap, the first band attachment being made up of a bendable cord and configured to be attached to a second end of the swivel attachment; and a second band attachment with the snap, the second band attachment being made up of a bendable cord and configured to be attached with the first band attachment with a strip.

In a further example embodiment, a cellular phone accessory for carrying a cellular phone securely and conveniently is disclosed. The cellular phone accessory consists of a phone case with flip in side portion for allowing the placement of a cellphone inside it and a flip on top portion to allow for connection with a swivel attachment. The phone case is held firmly against the inner side of hand of a user by a wrist band, a band attachment with snaps and an additional band connected to a metal ring.

### (G) BRIEF DESCRIPTION OF THE DRAWINGS

The example embodiments of the inventive concept will be better understood from the following brief description taken in conjunction with the accompanying drawings. The drawing FIGS. 1-15 represent non-limiting, example embodiments.

FIG. 1 shows a front and rear view of the phone casing and attachments with the Cell phone to be worn on hand and wrist, according to an example embodiment.

FIG. 2 shows the three-dimensional view of the phone casing and attachments with the Cell phone to be worn on hand and neck, according to an example embodiment.

FIG. 3 illustrates an embodiment of a mobile phone accessory having single band for holding the mobile phone, without casing, according to an example embodiment.

FIG. 4 illustrates an embodiment of a mobile phone accessory having two bands for holding the mobile phone, without casing, according to an example embodiment.

FIG. 5 illustrates an embodiment of a mobile phone accessory wearable in neck as necklace, according to an example embodiment.

FIG. 6 illustrates an embodiment of the mobile phone accessory of FIG. 3 having band with guide and locking mechanism, according to an example embodiment.

FIG. 7 illustrates an embodiment of the mobile phone accessory with the swivel, ring attachment and groove attachment at the circumference, according to an example embodiment.

FIG. 8 illustrates an embodiment of the mobile phone accessory with the swivel, ring attachment and groove attachment at the back of the case, according to an example embodiment.

FIG. 9 illustrates an embodiment of the mobile phone accessory with the swivel, ring attachment and groove attachment at the circumference and showing a finger attached to the ring attachment, according to an example embodiment.

FIGS. 10A-10C illustrates an embodiment of the mobile phone accessory with plurality of rings bands, according to an example embodiment.

FIG. 11 illustrates a cushion support in a ring attachment, according to an example embodiment.

FIG. 12A shows a metal ring attachment with swivel configured to move along the perimeter of the case, according to an example embodiment.

FIG. 12B shows a support ring attachment at the perimeter of the case, according to an example embodiment.

FIG. 13A-138 show hole and thread engagement configured to adjust the size of the necklace, according to an example embodiment.

FIG. 14 shows a layout of a hole and thread engagement according to another example embodiment of the invention.

FIG. 15 shows a layout of a hole and thread engagement, according to yet another example embodiment of the invention.

### (H) DETAILED DESCRIPTION OF THE INVENTION

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning us commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

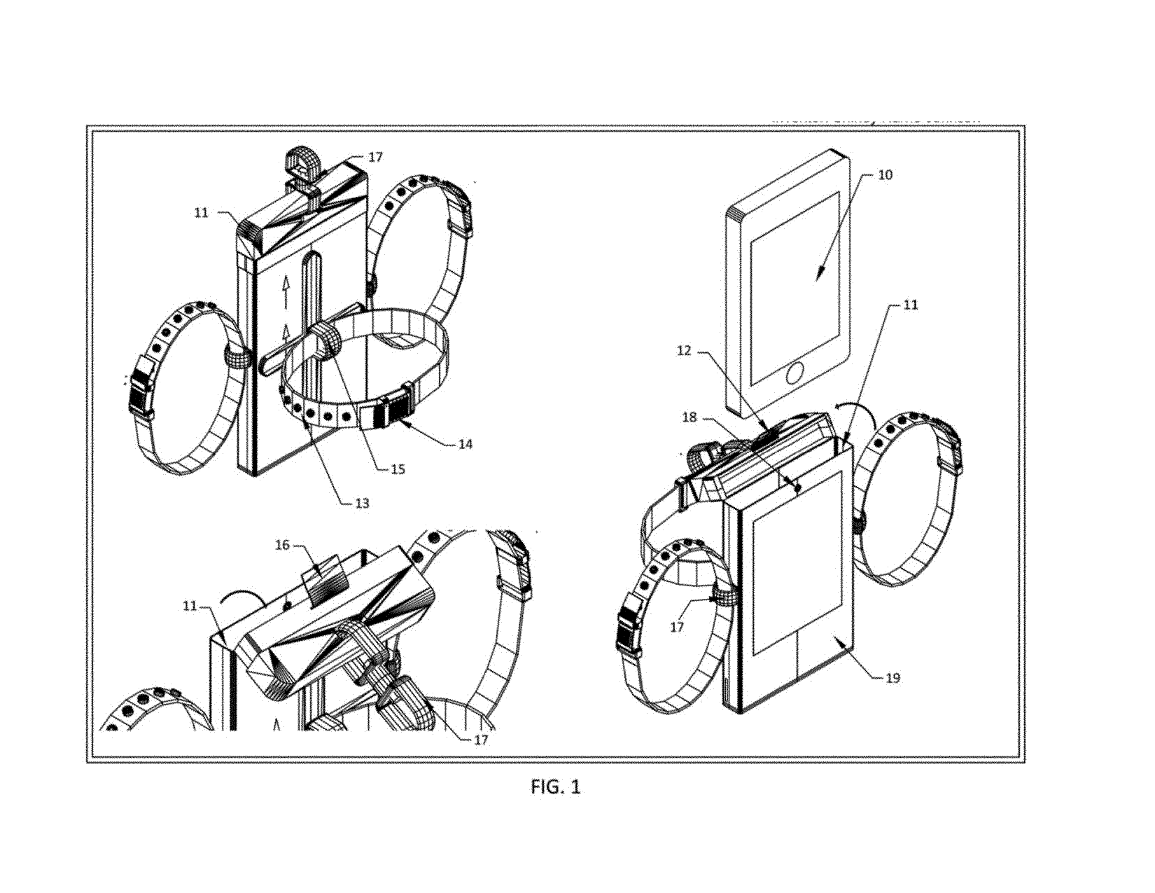

FIG. 1 shows front and rear view of a cellular phone accessory for carrying a cellular phone 10. The cellular phone accessory in the front view includes a snap 18 at top front portion of the phone case 19. The front flip 11 can be opened to insert or accommodate the phone 10.

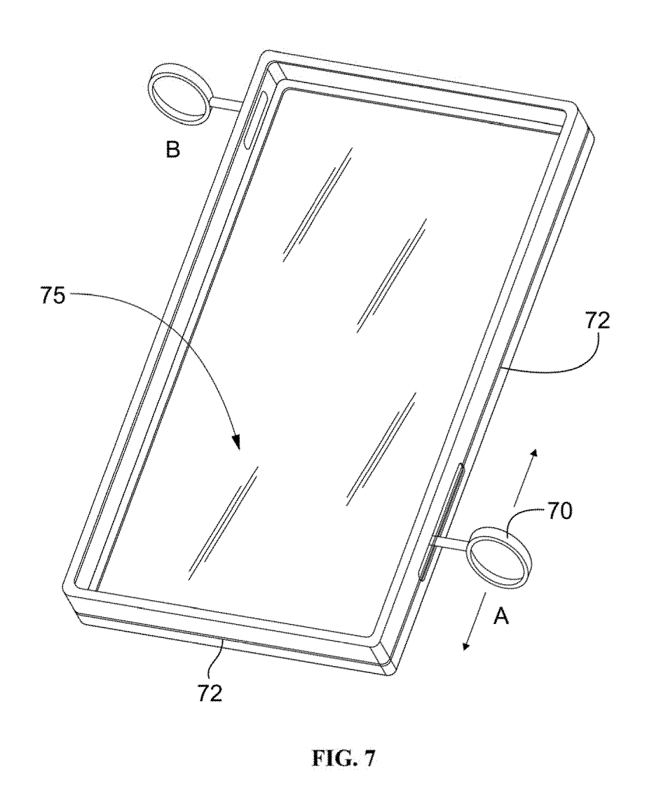

The FIG. 1 also shows straps 12, 16 extending from the flip 11, the straps 12, 16 can be secured to snap 18 to lock flip 11 when closed. In one embodiment, the straps 12, 16 can be extending from back of the cellular phone accessory such that it can be extended over the flip 11 upto snap 18 for locking the flip 11 when closed. Swivel 17 is attached to the side of the phone case 19 by means of a slit or groove 9. In an example embodiment, FIG. 7 also shows another groove or slit 72.

Further, the rear view of the cellular phone accessory shows a swivel 17 for necklace attachment, the swivel 17 is affixed to the flip 11 via groove or slit. The rear view of the cellular accessory also shows an adjustable velcro band 14 secured into a swivel 15 which is attached to the back side of phone case 19. The velcro band 14 includes one of an end with a locking mechanism and other end with snaps 13 placed along a part of the length of the other end. The velcro band 14 can be adjusted to fit in a wrist or finger/s of the user by securing the velcro band 14 using locking mechanism to one of the snaps 13.

The necklace arrangement has ability to swivel so the phone case can be turned around and can be used from different angles and positions and the necklace size and length may be adjusted to fit the person using it.

The cellular phone accessory is also shown having velcro bands 14 attached to side portion of the phone case 19 through swivels 17.

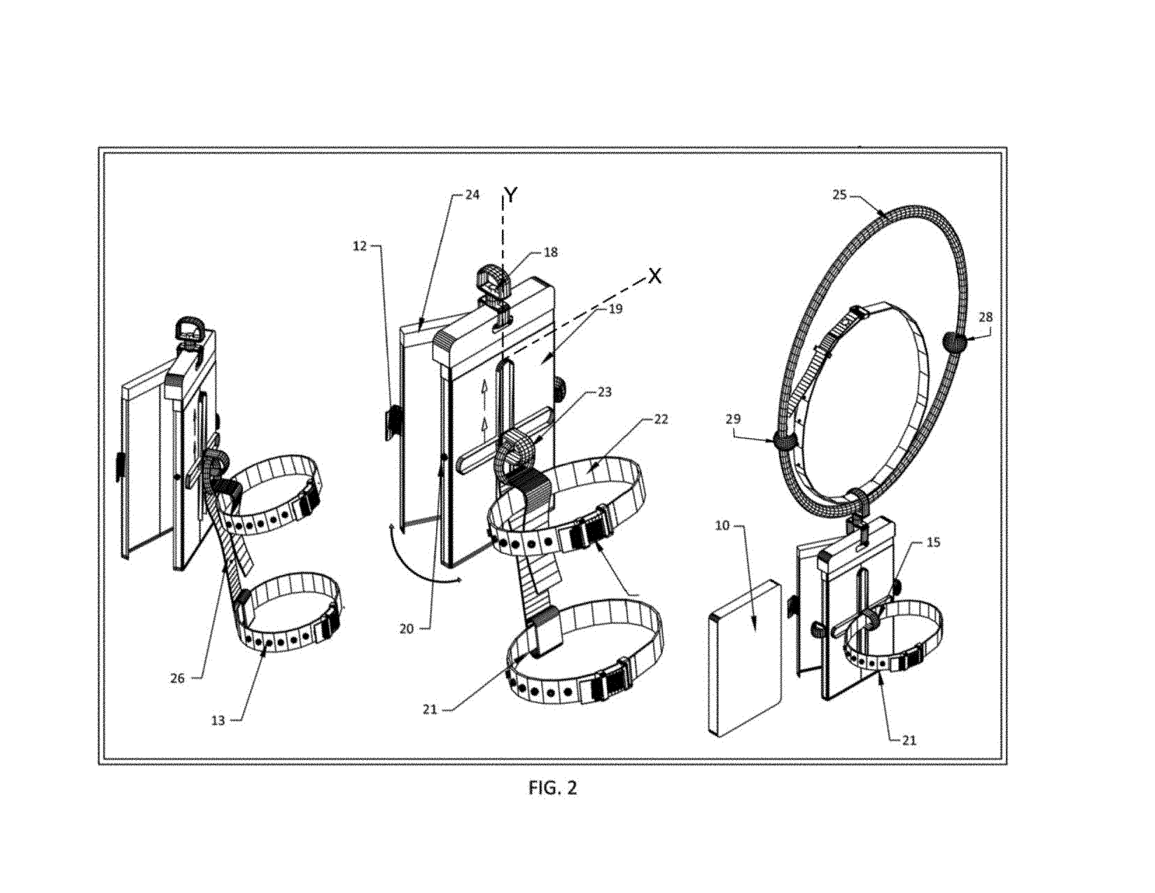

FIG. 2 shows cellular phone accessory with two velcro bands 21, 22, the upper band 22, and the lower band 21. The upper band 22 and the lower band 21 are attached to a strap 32. The lower band 21 is attached to one end of the strap. This strap 32 is secured into a ring attachment 23 that is inserted into the swivel 17 on the back of the cellular phone case 19. This strap is adjusted using snaps 26 provided along the length of the strap 32 between the places where the bands 21, 22 are attached.

The FIG. 2 further shows a flip 24 at a side portion of the mobile phone case 19 that can be opened to insert phone, and a snap 20 present at middle point on the side portion of the phone case 19. The flip 24 can be secured and locked by securing the strap 12 to the snap 20.

The FIG. 2 further shows an adjustable bands 21, 22 with snaps 13, and an adjustable necklace 25 attached to swivel 18. The necklace 25 includes engagement 28 and 29.

The bands 21, 22 can be adjusted to fit in a wrist or finger/s of the user by securing the bands 21, 22 using locking mechanism provided on the bands 21, 22 to one of the snaps 13. The cell phone accessories along with the attachments are so arranged that the users can access the cellphone by rolling their hand over. The cell phone accessory further has a ring slot and a back flip.

The swivel 17 is movable in vertical or horizontal directions over a predefined guided trajectories 33 provided on back portion of the mobile phone case 19. While setting the mobile phone as per users required comfort while holding the mobile phone accessory, the user can move the mobile phone accessory sideways by moving the swivel 17 along the horizontal trajectory, and for moving up-down, the user can move the swivel 17 on the vertical trajectory.

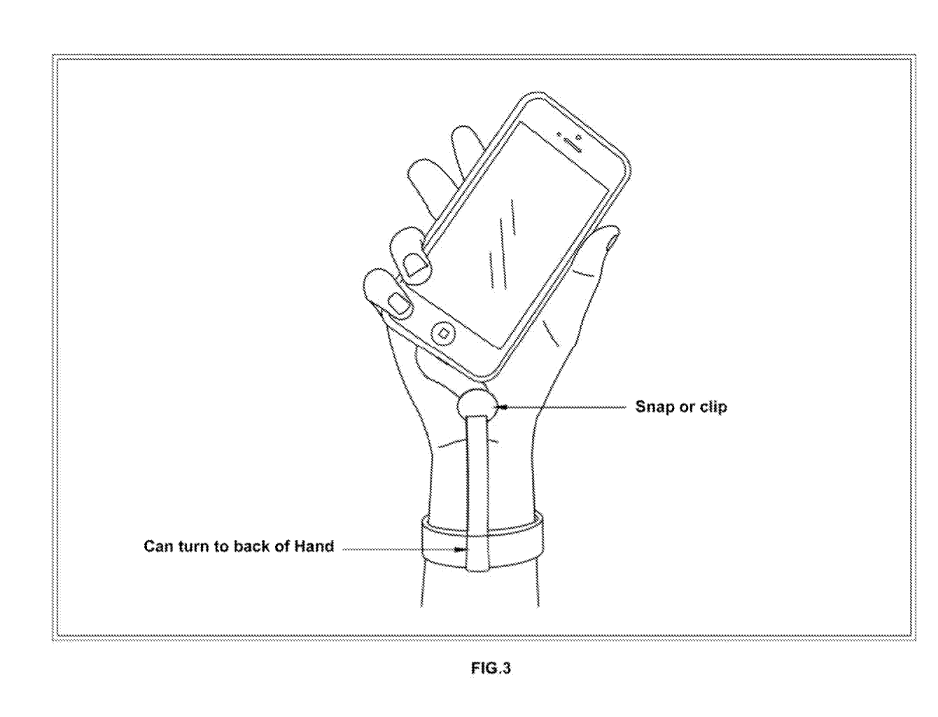

FIG. 3 discloses one of the embodiment of the invention, a cellular phone accessory which secures an article, preferably a mobile phone 10, which in use is secured to or worn on the body of a user through one strip 26 of a band 14. This strip 26 of band 14 is attached to a complementary strip 28 which is in turn attached to the mobile phone 10. The strip 26 of band 14 and the complimentary strip 26 are attached through a clip or snap 27. This helps in securing the mobile phone 10 to be releasably attached to the mobile accessory which can be worn on hand, wrist or finger of the user.

The mobile accessory can be worn onto the wrist, so that the strip 26 extending from the band 14 can be placed for mobile phone handling both on the side of the palm, and behind the palm.

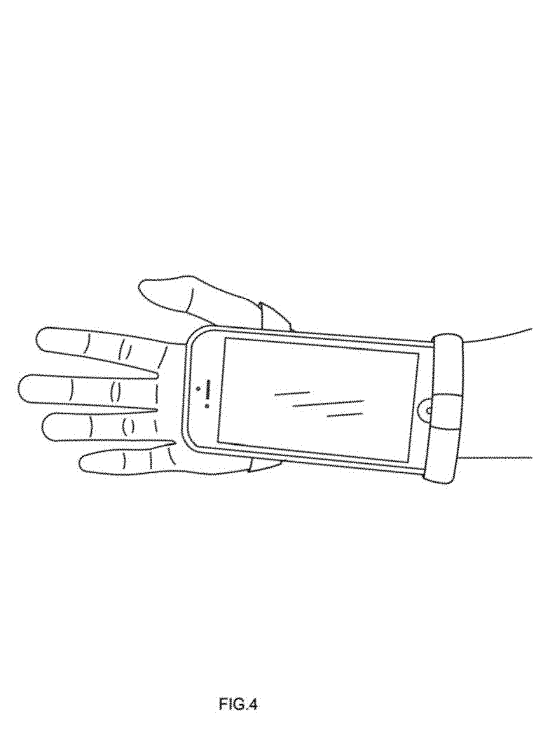

FIG. 4 discloses another embodiment of the mobile accessory, wherein more than one bands are provided, and the strips extending from the bands 21, 22 are secured to complimentary strips attached to the mobile phone using a fastening means.

For using the mobile accessory, the upper band 22 is placed through the fingers, with an attachment in the palm of the hand that swivels and on the hand/wrist the lower band 21 is upped or snapped or buckled around so the person could easily take it on or off.

The user by rolling his wrist or arm will cause the screen of the cellular phone to be visible without detaching the phone from the strap. Further, the phone 10 is operable by the user without having to detach it from the strap. In ether arrangements of the invention however, the phone may be detached from the article to be visible and to be used.

In a preferred embodiment of the present invention, the cell phone can be placed in a phone case that allows someone to place their hand inside the upper band 22 on the basis of the case which in turn prevents them from dropping and therefore, breaking the phone 10.

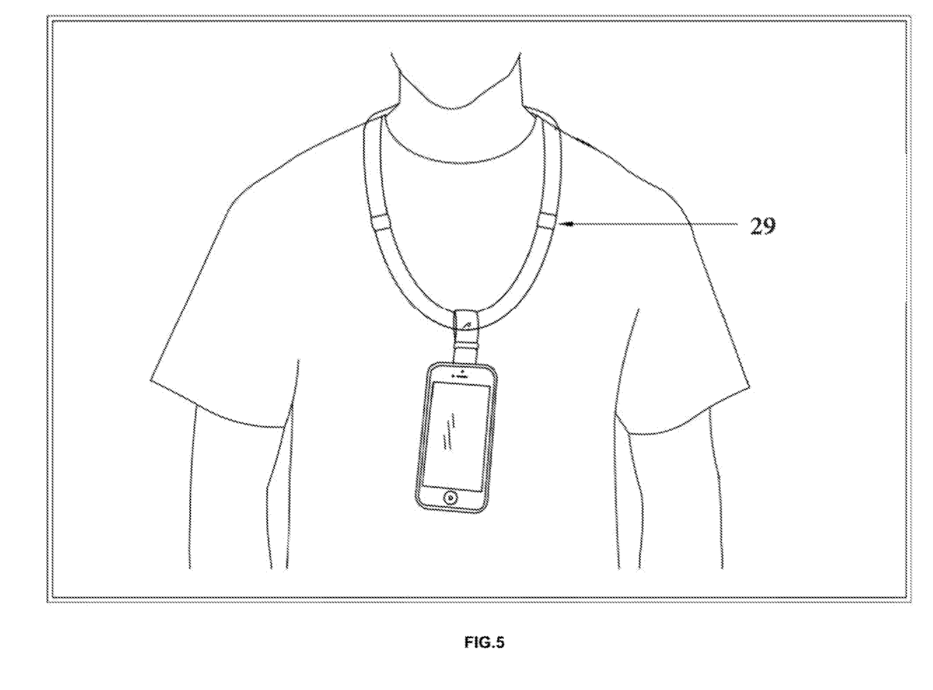

FIG. 5 illustrates an overall phone carrying accessory which is designed as a necklace 25 which can be worn around a user's neck, with a swivel base between the phone pouch and the necklace. To adjust the circumference of the necklace 25, a clip 29 is provided which can help in increasing or decreasing the circumference of the necklace 25 as per an optimal fit for each user.

The overall assembly allows the user to use the phone without taking it off from their neck and the user could turn the phone around or carry it like a purse under one arm. This will be advantageous for the user while shopping or doing anything else, as the user would be hands free and attach the ear plugs to hear, all without the need to put the phone down. It should be noted that the present invention is very helpful in accordance with the above-mentioned aspects, as the person can easily carry and quickly access the mobile phone without any hassle.

In one embodiment, the necklace 25 also has a case which is transparent from one side, and on the back side it can be of any material which can be transparent, translucent or opaque. The mobile is to be placed inside the case, in such a way that the number pad and screen of the mobile phone faces the transparent side of the case. The transparency allows user to dial the number, view the screen easily without taking mobile phone out of the case. In a further example embodiment, each of these ring attachments are provided with cushion support 112 inside the ring attachment.

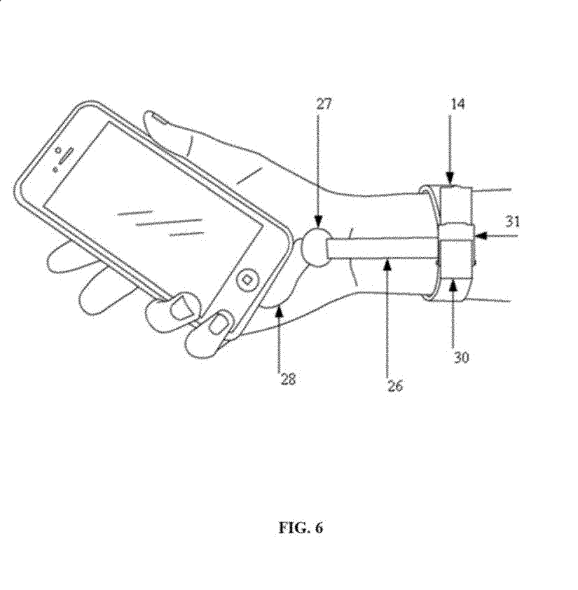

FIG. 6 illustrates another embodiment of mobile accessory of FIG. 3, where the band 14 includes a guide portion 30 and a lock 31. The band 14 is guided through the guide portion 30 for wrapping around hand, fingers or other body parts of a person, and when the band 14 is wrapped around to have a fitting on the body part, the lock 31 locks the band position to remain the band in the fitting position around the body part.

FIG. 7 illustrates another ring attachment 70 of a mobile accessory. A user can insert a finger in the ring attachment 70. The ring attachment 70 can swivel 360 degree around the mobile device by moving through a glider or groove (or slit) 72. The ring attachment 70 is flexible to be adjusted in size and can move or bend forward. The ring attachment 70 provides secured grip with the phone cover 75 while taking pictures, talking, texting or holding phone. In an example embodiment, the ring attachment 70 can slide halfway through and another ring attachment may be used to cover the other halfway of the complete loop.

In an example embodiment, the ring attachment 70 (which may also be referred to as ring and swivel attachment or simply swivel) is affixed to the case via a groove or slit means. The movement of the swivel is constrained along the groove or slit 72.

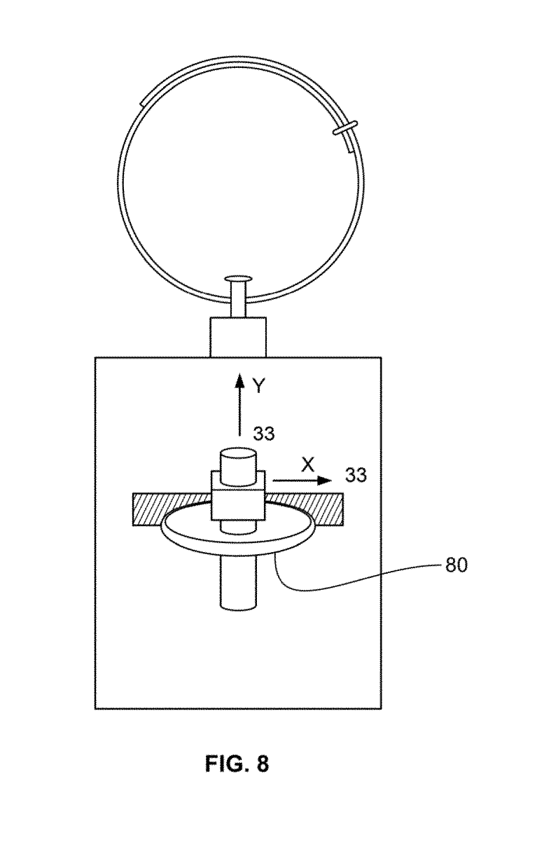

FIG. 8 illustrates another attachment ring attachment 80. In an example embodiment, the attachment ring 80 is inserted into a guide or groove mechanism in the case that allows the attachment ring to move up or down, left or right and swivel by 360 degree.

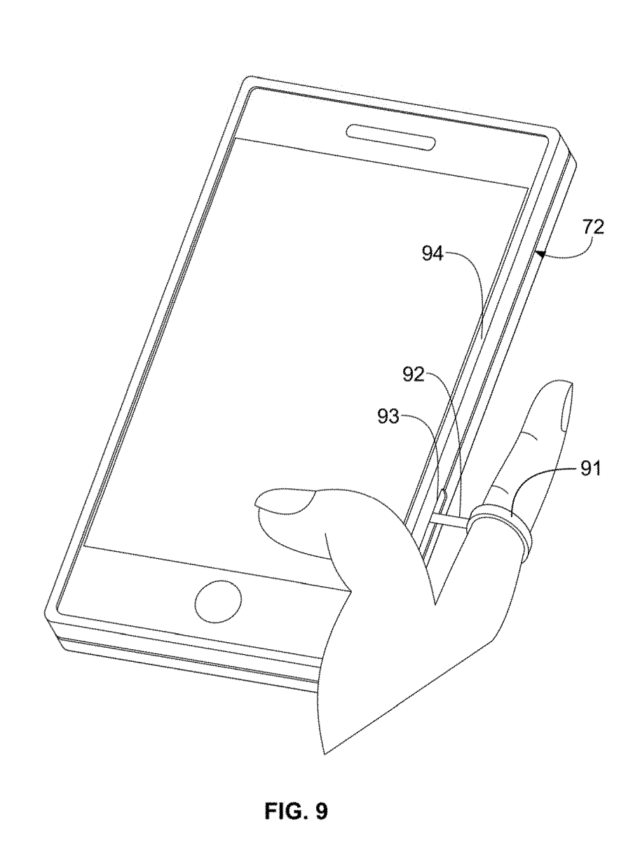

FIG. 9 illustrates closer view of another ring attachment 91 of a mobile accessory. A user can insert a finger in the ring attachment 91. The strap 92 facilitates in securing the ring attachment 91 to the groove or slit 93. The ring attachment 91 can swivel 360 degree around the mobile device by moving through a glider or grove and slit 93. The ring attachment 91 is flexible to be adjusted in size and can move or bend forward. The ring attachment 91 provides secure grip with the phone cover 94 while taking pictures, talking, texting or holding phone. In an example embodiment, the ring attachment 91 can slide halfway through and another ring attachment may be used to cover the other halfway of the complete loop.

In a further example embodiment, one or more attachment means described above are configured to expand or contract to accommodate one finger, plurality of fingers, the upper part of the hand and front and back part of wrist. The attachment means have an ability to retain a length so as to be able to maintain a size, grip or comfort level.

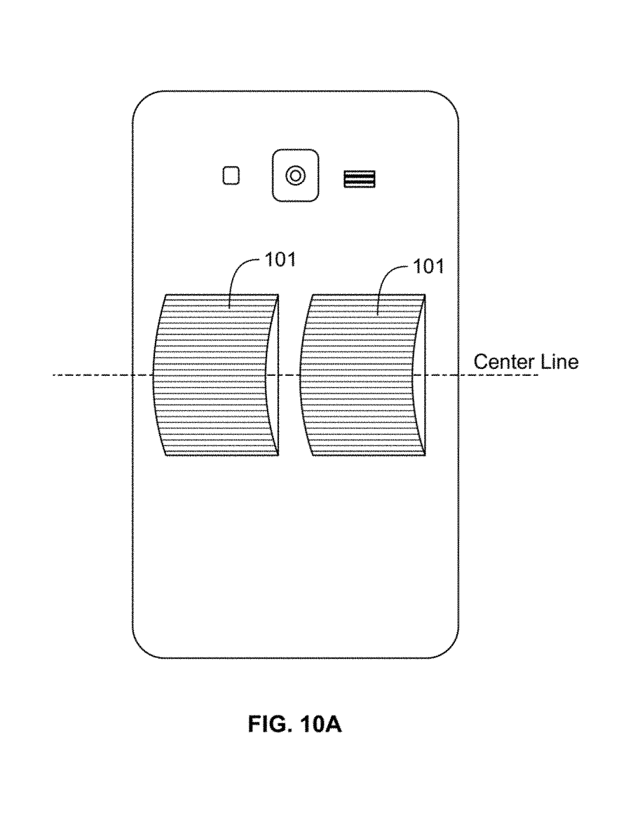

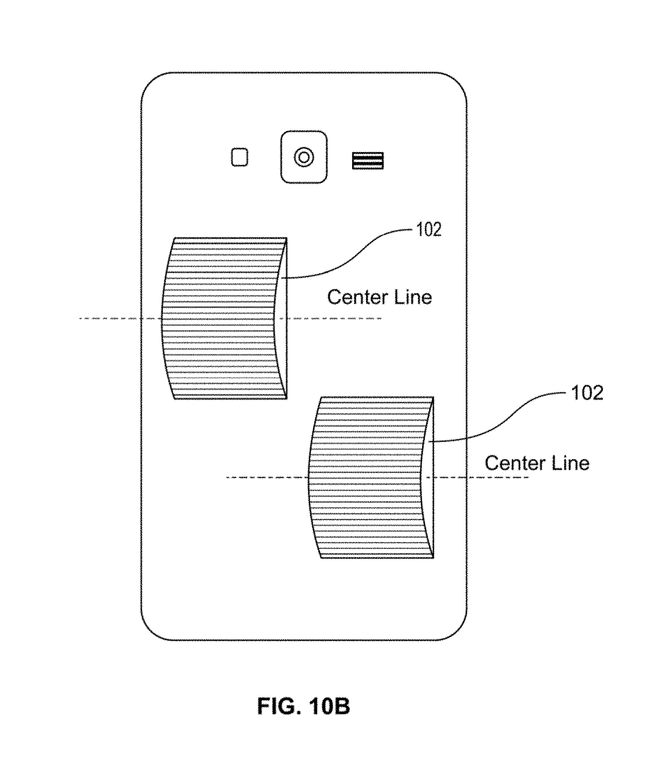

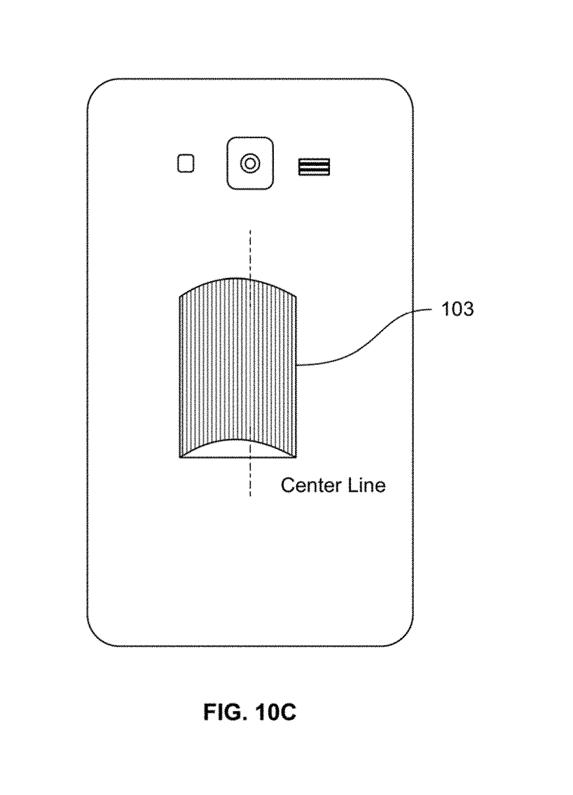

FIG. 10A-10C illustrate various ring attachments 101, 102, 103 to the mobile phones. Ring attachments 101 are parallel and aligned along the same center line. Ring attachments 102 are parallel but their center lines are displaced so that different fingers may be inserted to hold the phone. Ring attachment 103 is a single ring with the center line parallel to the length of the phone.

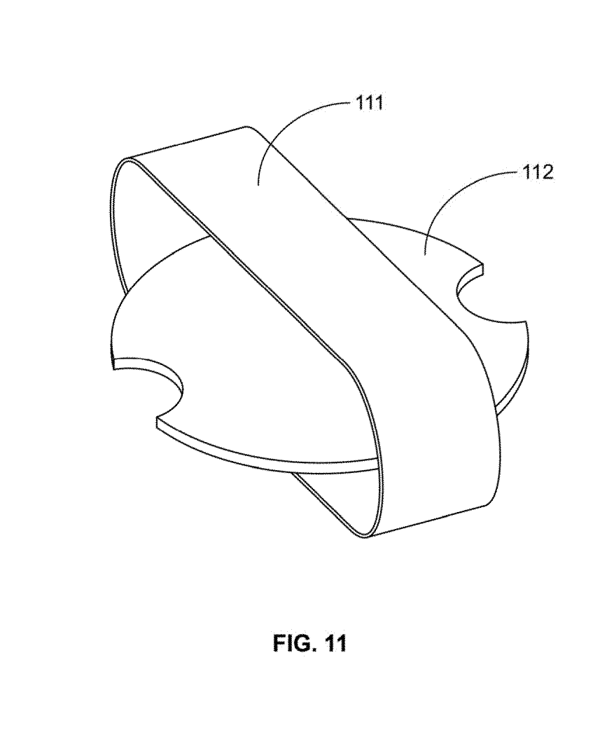

FIG. 11 illustrates a ring attachment 111 which is provided with a cushion support 112 for finger thereby reducing the strain put on the knuckle of the finger being used.

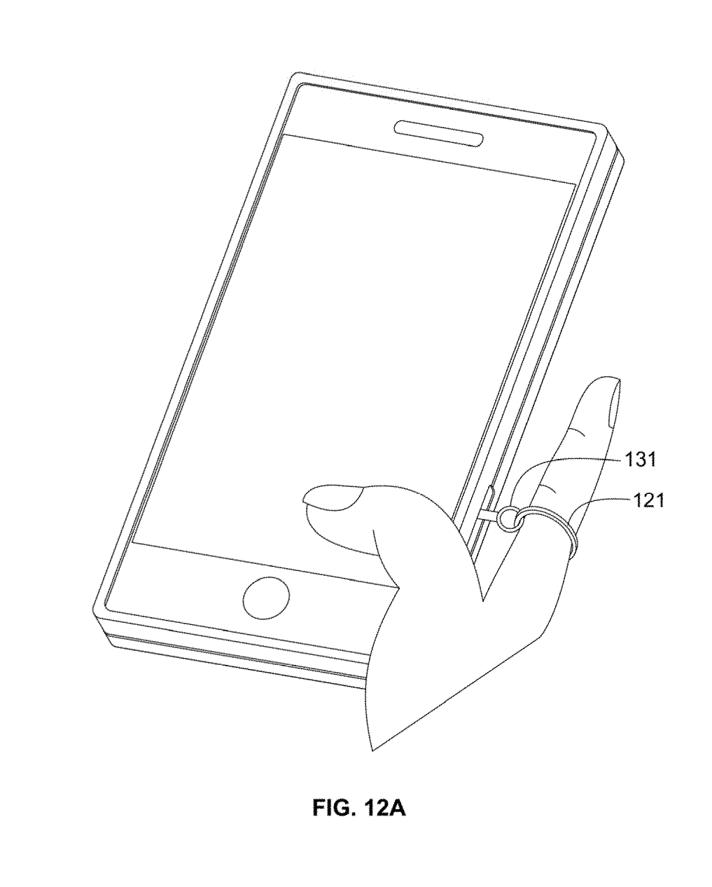

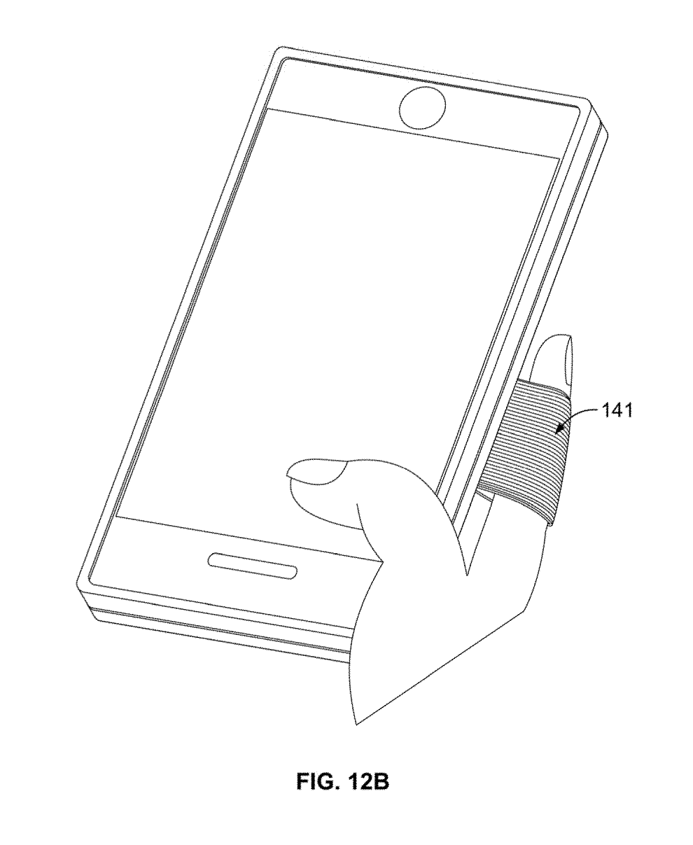

FIG. 12A illustrates a ring attachment 121 of a mobile accessory. The ring attachment 121 is secured to the mobile case by means of hook mechanism 131. In an example embodiment, the user can insert a finger into the ring attachment 121 which facilitates the one handed use of the phone without the device swiveling away while working on it. In an example embodiment, ring attachment 121 and hook are made of metal.

FIG. 12B illustrates a band-ring attachment 141 of a mobile accessory. The band-ring attachment 141 is secured to the side of the mobile case. In an example embodiment, the user can insert their finger into the band-ring attachment 141 and use the mobile device. This arrangement would facilitate the user in maintaining a better grip on the mobile device especially when using the device one-handed.

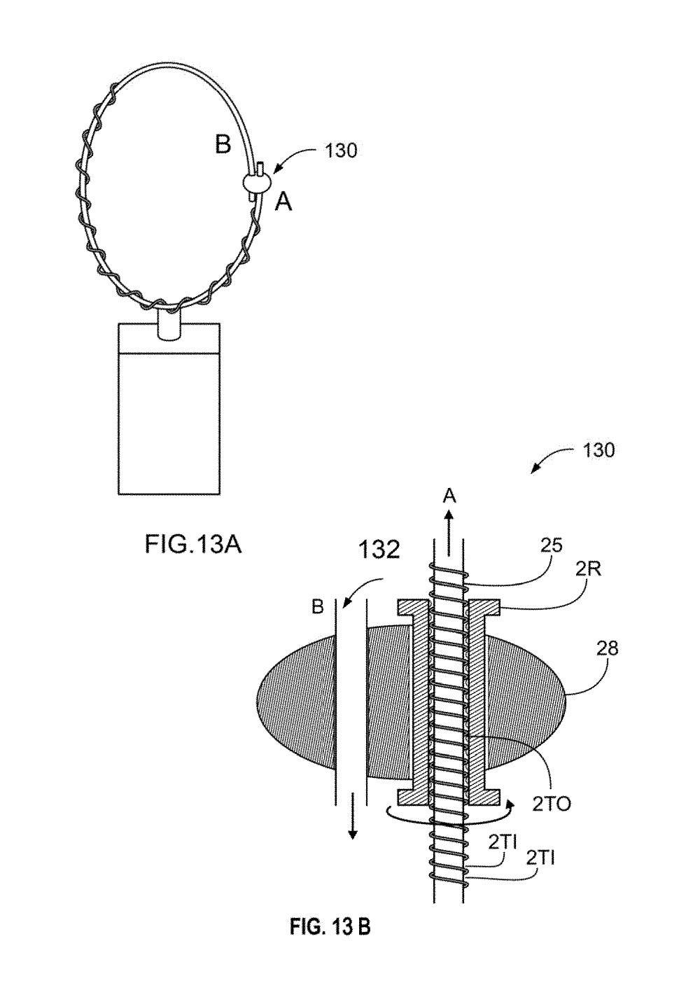

FIG. 13A illustrates necklace attached to a mobile device.

FIG. 138 illustrates the engagements arrangement 130 of the necklace to adjust the size of the necklace. In an example embodiment, engagement 130 comprises a polymer body 28, a pipe 2R configured to rotate and having threads 2TO in the in the inner wall and a second hole 132 with or without threads. The necklace includes corresponding threads 2TI. The corresponding threads 2TI are relatively soft and thick threads that fit with the threads 2TO. The polymer body 28 may be made of material such as silicone.

The end portions of the necklace (A and B) can pass through the holes of the pipe 2R. As the thread is rotated, the necklace advances through the hole adjusting the size (diameter or circumference) of the necklace.

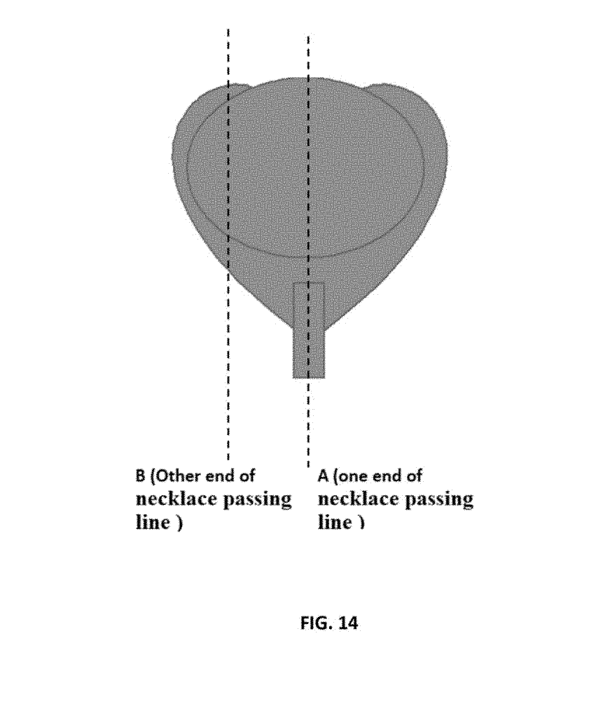

FIG. 14 shows a layout of the body 28 according to another example embodiment. A decorative may be printed on the layout 28. A and B show virtual lines on body 28 where the holes may be formed to make engagement 130.

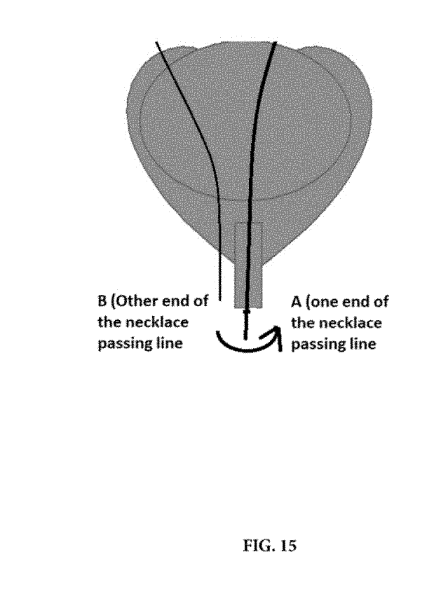

FIG. 15 shows a another layout of the body 28 according to another example embodiment. A decorative may be printed on the layout 28. A and B show virtual lines on body 28 where the holes may be formed to make engagement 130.

In a further example embodiment, the engagement may be an elastic engagement without threads such that the necklace may be pushed or pulled through the hole to change the size of the necklace. The necklace retains its size by the elastic grip of the elastic engagement with the necklace.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

While the invention has been illustratively described in its preferred form, it is not intended to limit the scope of the invention that follow to the specifics of that design form, in as much as variations equivalent thereto are feasible without departing from the novel inventive concepts involved. Plural instances may be provided for components, operations or structures described herein as a single instance. Finally, boundaries between various components and operations are somewhat arbitrary, and particular operations are illustrated in the context of specific illustrative configurations.

I claim:

1. An accessory for carrying a mobile device, the accessory comprising:
a case for the mobile device;
at least one swivel attachment; and
a groove formed on a perimeter and back of the case, the groove being configured to receive and retain the swivel attachment and allow movement of the swivel attachment along the groove.

2. The accessory according to claim 2, wherein the swivel attachment includes a ring at one end to be worn by a user.

3. The accessory according to claim 2, wherein the perimeter is configured such that the swivel attachment can move 360 around the mobile device.

4. The accessory according to claim 3, wherein the perimeter is configured such that the swivel attachment can move half way around the mobile device.

5. The accessory according to claim 4, wherein the swivel attachment and ring is made of metal.

6. The accessory according to claim 5, wherein the ring includes a memory foam adhered at an inner side of the ring for comfortable wearing of the ring.

7. An accessory for carrying a mobile device, the accessory comprising:
a case for the mobile device;
at least one swivel attachment; and
a first groove formed at a back of the case, the first groove being configured to receive and retain the first end of the swivel attachment and allow movement of the swivel attachment along the first groove;
a first band attachment with a snap, the first band attachment being made up of a bendable cord and configured to be attached to a second end of the swivel attachment; and
a second band attachment with the snap, the second band attachment being made up of a bendable cord and configured to be attached with the first band attachment with a strip.

8. The accessory according to claim 2, wherein the first band attachment and the second band attachment are configured to be opened and closed by a velcro for adjusting the length of the of bendable cord.

9. The accessory according to claim 8, wherein the first band attachment and the second band attachment are configured to be attached to wrist and forearm.

10. The accessory according to claim 7, wherein the first groove at the backside of the case is along X or Y, or X and Y directions.

11. The accessory according to claim 10, wherein a second groove is formed along the perimeter of the case.

12. The accessory according to claim 11, wherein a ring and swivel attachment is attached on the second groove.
